(19) United States
(12) Patent Application Publication
(10) Pub. No.: US 2007/0257566 A1
(43) Pub. Date: Nov. 8, 2007

(54) Synchronous Machine Using the Eleventh Harmonic

(75) Inventor: Rolf Vollmer, Gersfeld (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, 80333 Munchen (DE)

(21) Appl. No.: 11/575,186

(22) PCT Filed: Sep. 5, 2005
(86) PCT No.: PCT/EP05/54354

§ 371 Date: Mar. 13, 2007

(30) Foreign Application Priority Data
Sep. 15, 2004 (DE) 10 2004 044 697.0

(51) Int. Cl. H02K 37/00; H02K 1/00

(52) U.S. Cl. 310/46; 310/216

(57) ABSTRACT

A permanently-excited synchronous motor (1), comprises a stator (3) and a rotor (5), the stator (3) preferably comprising a three-phase alternating current winding and the rotor (5) permanent magnets. The stator (3) has 36 grooves (17) and 36 teeth (19), whereby only every other tooth (19) is wound with a coil (39). The rotor (5) has 22 magnetic poles. The permanently-excited synchronous motor may be embodied such that the number of effective pole pairs is a prime number.

The invention relates to a permanently excited synchronous machine.

Permanently excited synchronous machines, which exhibit excitation of a rotor by means of permanent magnets, have various advantages as against electrically excited synchronous machines. For example, the rotor in a permanently excited synchronous machine requires no electric connection. In this case, permanent magnets of high energy density, that is to say a large product of flux density and field strength, prove to be superior to the permanent magnets of lesser energy. Furthermore, it is known that permanent magnets can exhibit not only a flat arrangement in relation to the air gap, but can also be positioned in a type of group configuration (flux concentration).

Disadvantageous pulsating torques can occur with permanently excited synchronous machines. Skewing a rotor or a stator of the permanently excited synchronous machine by, for example, one slot pitch, as is described for conventional motors in EP 0 545 060 B1, can lead to a reduction in the torque. In the case of permanently excited synchronous machines with conventional winding, that is to say windings that are produced using pull-in technology, it is customary to undertake skewing by one slot pitch, in order to reduce detent torques, which can also lead to pulsating torques.

It is possible, for example, to reduce the pulsating torques by means of a particular shaping of the magnets in the case of permanently excited synchronous machines that have tooth-wound coils. There is the disadvantage here that a particular shaping of the magnets leads to increased production costs.

Consequently, it is the object of the invention to specify a permanently excited synchronous machine in the case of which pulsating torques and/or detent torques are reduced in a simple way. This reduction is advantageously performed without, for example, skewing the permanent magnets.

The object set is achieved in the case of a permanently excited synchronous machine with the aid of the features as claimed in claim 1 or 6. The subclaims 2 to 5 and 7 to 11 are further advantageous developments of the permanently excited synchronous machine.

In the case of a permanently excited synchronous machine that has a stator and a rotor, the stator preferably having a three-phase winding and the rotor having permanent magnets, the stator is constructed in such a way that it has 36 slots and 36 teeth. Only every second tooth is wound with a coil in this case. The rotor is constructed in such a way that it has 22 magnetic poles. The coil that is wound around a tooth is advantageously a tooth-wound coil. Such a permanently excited synchronous machine has 18 poles on the stator.

As a result of the embodiment described, the permanently excited synchronous machine advantageously has a high utilization and a high power factor.

A high winding factor can be achieved by means of such a permanently excited synchronous machine. The combination of 22 poles on the rotor and 36 slots in the stator leads to a first possible number of detent pole pairs of pr=396. The number of detent pole pairs is yielded from the kgV of the 36 slots of the stator with the 22 poles of the rotor. Since the number of poles of the rotor, that is to say the number of magnetic poles of the rotor, is 22, the rotor therefore has 11 magnetic pole pairs. Consequently, the permanently excited synchronous machine has a number of magnetic poles that is a prime number. This has the advantage that the kgV (N1, 2p) is relatively high.

A spectrum of air gap fields can be generated by means of an energized winding of the stator. Harmonic fields and a basic field can be distinguished over the circumference of 360 degrees from a consideration of this spectrum of air gap fields. The number of basic pole pairs of the basic field is pg. It holds for the number of poles of the harmonic fields that:

pi>pg. A number of basic pole pairs of pg=1 results in the case of the inventive permanently excited synchronous machine. A number of useful pole pairs pn results from the number of rotor pole pairs, and is therefore 11, since the rotor has 11 magnetic pole pairs.

This results in the use of an eleventh harmonic for the permanently excited synchronous machine. The fundamental wave and the harmonics of a field profile in an air gap of an electric machine can be determined, for example, by means of Fourier analysis.

In an advantageous refinement, the winding of the stator is designed in such a way that, in particular, disturbing harmonics such as the fifth and seventh harmonic of the number of useful pole pairs p_{N} have only a small amplitude. The fifth and the seventh harmonic of the number of useful pole pairs pn are disadvantageous, in particular, because they generate pulsating torques with the corresponding harmonics of the rotor field.

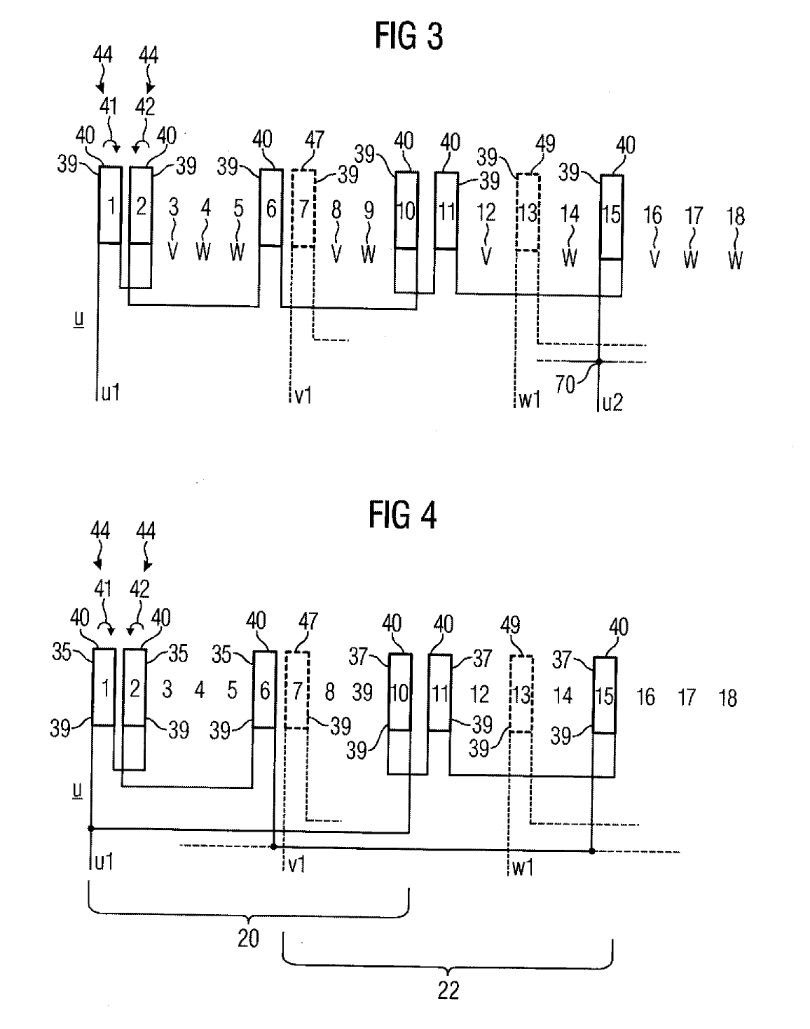

A reduced formation of detent torque results from the use of the inventive permanently excited synchronous machine with a specific combination from a number of slots in the stator and a specific number of rotor poles. The lesser formation of detent torque is a result, in particular, of the winding design, in the case of which only every second tooth of the stator is wound with a tooth coil. The stator of the permanently excited synchronous machine advantageously has a winding in accordance with FIGS. 2 and 3. The respective winding is described in more detail in the description of the Figures.

The permanently excited synchronous machine that has a stator and a rotor, the stator having a three-phase winding and the rotor having, in particular, permanent magnets can, for example, be constructed such that the stator has 36 slots and 36 teeth, only every second tooth being wound with a coil and the coils having a first winding direction e and a second winding direction z, the first winding direction e being opposite to the second winding direction z. The first winding direction e corresponds, for example, to a winding in a clockwise direction, and the second winding direction z to a winding counter to the clockwise direction. The coils of a phase can be connected in series in this case, coils of a phase U, V, W that are connected in series constructing at least one coil group, the wound teeth being wound in accordance with the following table:

| | Wound tooth | | | | | | | | | | | | | | | | | |
|---|---|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 | 17 | 18 |
| Phase U | e | z | | | | e | | | | z | e | | | | z | | | |
| Phase V | | | z | | | | e | z | | | | e | | | | z | e | |
| Phase W | | | | z | e | | | | z | | | | e | z | | | | e |

The rotor has 22 magnetic poles, in particular.

In one embodiment of the synchronous machine all the coils that are assigned to a phase U, V or W are connected in series. In a further embodiment:
a) for the phase U the coils of the first, second and sixth wound tooth are connected in series in order to construct a first coil group of the phase U, and the coils of the tenth, eleventh and fifteenth wound tooth are connected in series in order to construct a second coil group of the phase U, and
b) for the phase V the coils of the third, sixteenth and seventeenth wound tooth are connected in series in order to construct a first coil group of the phase V, and the coils of the seventh, eighth and twelfth wound tooth are connected in series in order to construct a second coil group of the phase V, and
c) for the phase W the coils of the fourth, fifth and ninth wound tooth are connected in series in order to construct a first coil group of the phase W, and the coils of the thirteenth, fourteenth and eighteenth wound tooth are connected in series in order to construct a second coil group of the phase W.

Three coils of a phase are thus combined to form a coil group. The coils of a coil group are connected in series. The coil groups can be connected in series or they can also be connected in parallel.

A further object of the invention is to specify a permanently excited synchronous machine having a specific stator laminate section and a specific winding (see FIGS. 2 and 3) for energization by three-phase current, in the case of which the permanently excited synchronous machine exhibits small detent torques and small harmonics without skewing of stator and/or rotor. The harmonics relate to the magnetic field profile in an air gap between stator and rotor. Consequently, the harmonics also relate to the EMF, and may therefore also be described as EMF harmonics.

The inventive permanently excited synchronous machine has advantages over the prior art, particularly in the case of low speed and high torques. Such an application with low speed and high torques is typically found in the case of torque motor applications. The permanently excited synchronous machine is thus advantageously a torque motor.

An advantageous refinement of the permanently excited synchronous machine has a wound tooth and neighboring slots of the wound tooth, the wound tooth and the neighboring slots having parallel flanks. Both the tooth and the slots have flanks. These flanks run in parallel. This has, for example, the advantage of simple mounting of the winding of the tooth. The winding is, in particular, a tooth winding, the slots that are present on both sides of a tooth being filled by the winding of the tooth.

In a further advantageous refinement, the stator is wound with flat wire or with flat litz wire. This enables a higher degree of filling of the slots with copper.

Furthermore, the permanently excited synchronous machine can be configured in such a way that a phase is assigned six coils, all six coils of the phase being connected in series. A phase thus has six coils that can be energized in a series connection.

In a further refinement, a phase is assigned six coils, in turn, the coils being divided into two coil groups, one coil group advantageously having three coils, which are connected in series, and the two coil groups being connected in parallel.

A further advantageous refinement of the permanently excited synchronous machine has a stator that has wide teeth and narrow teeth, a slot pitch width ans for the narrow teeth being in the range of 9.1°>ans>3°, and a slot pitch width anb for the broad teeth being in the range of 10.9°<anb<17°, in which case it holds that anb+ans=20°.

Furthermore, the permanently excited synchronous machine can be configured in such a way that there is a hole number of q=6/11. The hole number q specifies the number of slots per pole over which the winding of a phase is divided, and so q is the number of slots per pole and phase.

In order to keep low detent torques of permanent magnets of the rotor with stator teeth, it is necessary to select the number of slots and number of poles such that the least, common multiple is as high as possible. This is achieved when the number of pole pairs (number of useful pole pairs) is a prime number. The number of useful pole pairs is thus a prime number.

According to the invention, a stator section with 36 slots and 18 poles, and a winding with the number of basic pole pairs pg=1 and a number of useful pole pairs pn=11 are determined. The least common multiple is thus 396. Consequently, there is a number of reluctance detent pole pairs of pr=396, and thus relatively small detent torques, because the rotor field, leading to detenting, of the number of magnetic pole pairs prm=198 (=9th rotor harmonic) has a small amplitude.

The slot pitch width is advantageously between 0.66 and 1.23 of the pole pitch width of the rotor.

The invention and advantageous refinements of the invention are explained in more detail below with the aid of the drawing, in which:

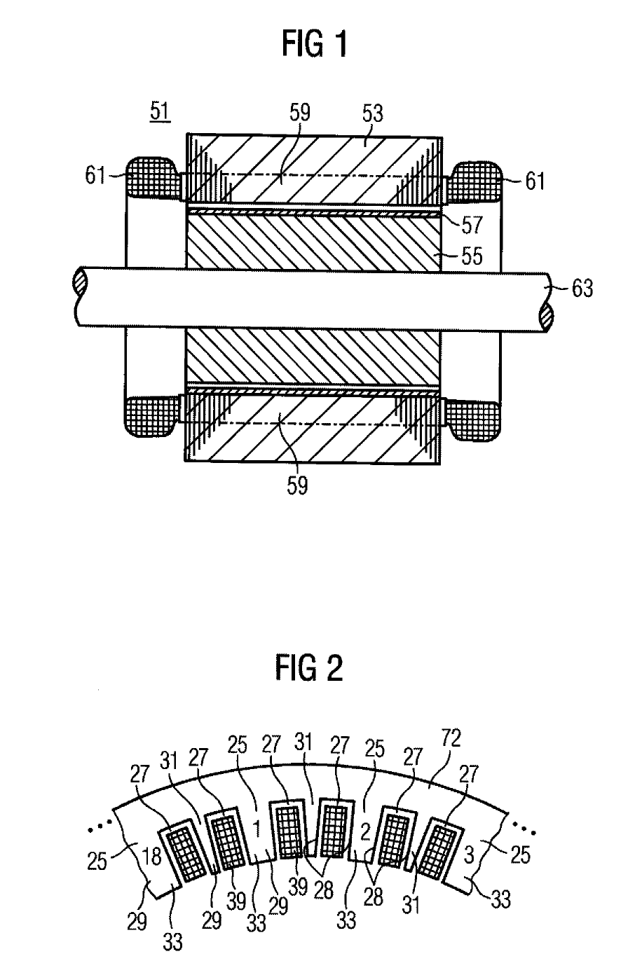

FIG. 1 shows a schematic of the design of a permanently excited synchronous machine,

FIG. 2 shows a schematic section of a laminate section of a stator of a permanently excited synchronous machine,

FIG. 3 shows a first winding diagram and

FIG. 4 shows a further winding diagram.

The illustration in accordance with FIG. 1 shows a permanently excited synchronous machine 51 that has a stator 53 and a rotor 55. The rotor 55 has permanent magnets 57. The stator 53 has coils 59, the profile of the coil 59 inside the laminated stator 53 being illustrated by dots and dashes. A winding is constructed with the aid of the coil 59. The coils 59 construct winding overhangs 61. The permanently excited synchronous machine 51 is provided for driving a shaft 63.

The illustration in accordance with FIG. 2 shows a schematic section of a laminate section 72. The laminate section 72 relates to the stator 53 of the permanently excited synchronous machine 51. The laminate section 72 has teeth 29 and slots 27. When a tooth 29 is wound, it is a wound tooth 25. The wound teeth 25 are enumerated from 1 to 18. The stator 53 with the laminate section 72 has 18 wound teeth. A tooth is wound by mounting a coil 39, for example. This can be done with particular ease when the wound tooth 25 and the neighboring slots 27 of the wound tooth 25 have parallel flanks. The teeth 29 and the slots 27 have flanks 28. These flanks 28 are of parallel design. The schematically illustrated section of the laminate section 72 shows that winding takes place only for every second tooth 29. Every second tooth 29 is thus wound around with a tooth coil 39. Prefabricated preformed coils can advantageously be used to this end. Owing to the parallelism of the tooth 25 that is to be wound around, and to the parallelism of the slots 27 that are to be filled by the coil 39, preformed coils made from flat wire can advantageously be used such that there is a particularly high copper filling factor in the slots 27.

Permanently excited synchronous machines that can, in particular, be used as motors can be built with low losses and thus a high utilization owing to the measures described.

The laminate section 72 alternately has a narrow tooth 31 and a wide tooth 33. By means of the targeted selection of the slot pitch width of the wide tooth 33 and of the narrow tooth 31, it is possible, together with the selection of the winding connections, particularly in accordance with FIGS. 3 and 4, to set an air gap field of a working shaft high, and to set the disturbing harmonics low. A low torque ripple is thereby attained in addition to the high utilization,

The illustration in accordance with FIG. 3 shows a first winding diagram for a stator that has 36 slots. The rotor has 22 poles (magnetic poles), that is to say 11 pole pairs, the rotor not being illustrated in FIG. 3. In accordance with the winding diagram according to FIG. 3, the stator 18 has coils 39, six coils 40 being illustrated for a phase U in accordance with FIG. 3. The coils 40 of the phase U are illustrated in FIG. 3 with a continuous line. The winding diagram relates to a permanently excited synchronous machine that can be energized by three phases U, V, W of a three-phase current. The winding of the phase U is illustrated in FIG. 3 with all the coils 40. For the windings of the phases V and W, it is in each case only the first coil 47 that is illustrated for the phase V, and the coil 49 for the phase W. The coils 47 and 49 of the phases V and W are illustrated by dashes in FIG. 3. The winding of the phases V and W corresponds to the winding of the phase U, the winding not being completely illustrated, in order to provide a better overview. Connections of the phases U, V and W are denoted by u1, u2, v1, v2, w1 and w2.

The illustration in accordance with FIG. 3 shows teeth that are symbolized by numbers from 1 to 18, the teeth being wound with coils 39. A schematic preparation of the winding diagram was selected for the purpose of simple illustration. Every second tooth of a permanently excited synchronous machine that has a winding diagram according to FIG. 3 is wound. In FIG. 3, only the wound teeth 1 to 18 are numbered. An unwound tooth is located between two wound teeth that are numbered from 1 to 18, unwound teeth not being illustrated in FIG. 3, as is also the case in the subsequent FIG. 4. A first coil 40 of the phase U is wound around the tooth 1 in a first winding direction 41. It is followed by a winding around the tooth 2 in a second winding direction 42. The tooth 2 is the second windable tooth. The first winding direction 41 is opposite to the second winding direction 42. Between the tooth 1 and the tooth 2 there is further an unwound tooth that is not illustrated in FIG. 3. There is a corresponding situation for the teeth 3, 4, 5, 6 etc, between which there is a further respective tooth that is, however, not illustrated.

The coil 40 around the tooth 2 has a winding direction 44 opposite to the coil around the tooth 1. The coil 40 around the tooth 2 follows for the phase U a coil 40 around the tooth 6. Thereafter, a coil 40 follows around the teeth 10, 11 and 15. The winding direction 44 changes after each coil of the phase U. The winding directions 44 of the coils for the phases V and W correspond to the winding directions of the coils 40 of the phase U.

The first coil 47 of the phase V is located on the tooth 7. This coil 47 is followed by a coil around the tooth 8 which is, however, not illustrated. The coil around the tooth 8 has a winding direction opposite to the coil 47 around the tooth 7. The winding directions of the phase V and the phase W correspond to the winding directions of the phase U. Thus, in the case of all the phases the winding direction changes after each coil. The first coil 49 of the phase W is located on the tooth 13. The six coils 40, which are in each case assigned to a phase U, V and W, are connected in series.

The illustration in accordance with FIG. 4 shows a further possible coil arrangement or a further possible winding diagram for the inventive permanently excited synchronous machine. The winding diagram according to FIG. 4 largely corresponds to the winding diagram according to FIG. 3, a parallel connection of coil groups 20 and 22 being implemented in accordance with FIG. 4. As in the case of FIG. 3, a phase is assigned six coils in the case of FIG. 4, as well. The winding directions 41, 42 of the winding circuit according to FIG. 4 correspond to the winding directions 41, 42 according to FIG. 3.

The six coils 40 of a phase are subdivided into two groups 20 and 22. A first group 20 has three coils 35, and a second group 22 in turn has three coils 37. The two groups 20, 22 of coils 35, 37 are connected in parallel. A first coil group 20 of the phase U begins with a coil 35 around the tooth 1. Following thereupon is a coil 35 around the tooth 2, the winding direction 44 respectively being reversed as in the case of the winding in accordance with FIG. 3. The third coil of the first coil group 20 is at the tooth 6. A second coil group 22 of the phase U begins with a coil 37 around the tooth 10. Following thereupon is a coil 37 around the tooth 11. The third coil of the second coil group 22 is at the tooth 15. In the case of the winding with the two coil groups 20, 22 in accordance with FIG. 4, the winding direction 44 is likewise reversed after each wound tooth of a phase. The windings for the phases V and W correspond to the winding for the phase U.

A leading coil 47, 49 that runs around the tooth 7 for the phase V and around the tooth 13 for the phase W is respectively shown, in turn, for the phases V and W.

Both the winding in accordance with FIG. 3 and the winding in accordance with FIG. 4 advantageously have star connections. If the aim is to design a permanently magnetically excited synchronous machine for a delta connection, measures that prevent the pole number p3n=3*pn from resulting are advantageously to be taken.

1.-11. (canceled)

12. A permanently excited synchronous machine, comprising:
a stator having 36 slots and 36 teeth, only every second tooth being wound with a coil; and
a rotor having permanent magnets, said rotor interacting with said stator and having a number of useful pole pairs, said number of useful pole pairs being a primary number.

13. The permanently excited synchronous machine of claim 12, wherein said rotor has 22 magnetic poles.

14. The permanently excited synchronous machine of claim 12, further comprising phases in said winding, said coils being assigned to respective phases and coils assigned to a respective phase being connected in series.

15. The permanently excited synchronous machine of claim 14, wherein six coils are assigned to a respective phase and said 6 coils are connected in series.

16. The permanently excited synchronous machine of claim 151 further comprising two groups of said coils within said six coils assigned to a respective phase, said two groups of coils being connected in parallel.

17. The permanently excited synchronous machine of claim 12, wherein said coils have a first winding direction and a second winding direction, said first winding direction being opposite to said second winding direction, said winding having three phases, said wound teeth being sequentially numbered 1-18, and
a) for the first phase the first wound tooth is wound in the first winding direction, the second wound tooth is wound in the second winding direction, the sixth wound tooth is wound in the first winding direction, the tenth wound tooth is wound in the second winding direction, the eleventh wound tooth is wound in the first winding direction, the fifteenth wound tooth is wound in the second winding direction, said coils on the wound teeth for said first phase being connected in series;
b) for the second phase the seventh wound tooth is wound in the first winding direction, the eighth wound tooth is wound in the second winding direction, the twelfth wound tooth is wound in the first winding direction, the sixteenth wound tooth is wound in the second winding direction, the seventeenth wound tooth is wound in the first winding direction, the third wound tooth is wound in the second winding direction, said coils on the wound teeth for said second phase being connected in series; and
c) for the third phase the thirteenth wound tooth is wound in the first winding direction, the fourteenth wound tooth is wound in the second winding direction, the eighteenth wound tooth is wound in the first winding direction, the fourth wound tooth is wound in the second winding direction, the fifth wound tooth is wound in the first winding direction, the ninth wound tooth is wound in the second winding direction, said coils on the wound teeth for said third phase being connected in series.

18. The permanently excited synchronous machine of claim 12, wherein said coils have a first winding direction and a second winding direction, said first winding direction being opposite to said second winding direction, said winding having three phases, said wound teeth being sequentially numbered 1-18, and
a) for the first phase the first wound tooth is wound in the first winding direction, the second wound tooth is wound in the second winding direction, the sixth wound tooth is wound in the first winding direction, the tenth wound tooth is wound in the second winding direction, the eleventh wound tooth is wound in the first winding direction, the fifteenth wound tooth is wound in the second winding direction, said coils on the first, second and sixth wound teeth being connected in a first series, said coils on the tenth, eleventh and fifteenth wound teeth being connected in a second series, and said first and second series being connected in parallel;
b) for the second phase the seventh wound tooth is wound in the first winding direction, the eighth wound tooth is wound in the second winding direction, the twelfth wound tooth is wound in the first winding direction, the sixteenth wound tooth is wound in the second winding direction, the seventeenth wound tooth is wound in the first winding direction, the third wound tooth is wound in the second winding direction, said coils on said seventh, eighth and twelfth wound teeth being connected in a first series, said coils on said sixteenth, seventeenth and third wound teeth being connected in a second series, and said first and second series being connected in parallel; and
c) for the third phase a thirteenth wound tooth is wound in the first winding direction, a fourteenth wound tooth is wound in the second winding direction, a eighteenth wound tooth is wound in the first winding direction, the fourth wound tooth is wound in the second winding direction, the fifth wound tooth is wound in the first winding direction, the ninth wound tooth is wound in the second winding direction, said coils on the thirteenth, fourteenth and eighteenth wound teeth being connected in a first series, said coils on said fourth, fifth and ninth wound teeth being connected in a second series, and said first and second series being connected in parallel.

19. The permanently excited synchronous machine of claim 12, further comprising a slot pitch width that is between 0.66 and 1.23 of a pole pitch of the rotor.

20. The permanently excited synchronous machine of claim 12, further comprising a star connection in said winding.

21. The permanently excited synchronous machine of claim 12, further comprising a delta connection in said winding, and a pole number such that p3n≠3*pn.

22. The permanently excited synchronous machine of claim 12, further comprising neighboring slots on each side of a wound tooth, a flank of said neighboring slot and of said wound tooth being parallel flanks.

23. The permanently excited synchronous machine of claim 12, wherein said stator winding is a flat wire.

24. The permanently excited synchronous machine of claim 12, wherein said stator winding is a flat litz wire.

25. The permanently excited synchronous machine of claim 12, wherein said stator has wide teeth and narrow teeth, a slot pitch width ans for said narrow teeth being in the range of 9.1°>ans>3°, and a slot pitch width anb for said broad teeth being in the range of 10.9°<anb<17°.

26. The permanently excited synchronous machine of claim 25, wherein anb+ans=20°.

27. The permanently excited synchronous machine of claim 12, wherein the hole number q=6/11.

28. The permanently excited synchronous machine of claim 12, wherein said coil is a tooth-wound coil.

29. The permanently excited synchronous machine of claim 12, wherein said permanent magnets provide eleven useful magnetic pole pairs so that the eleventh harmonic of the field is used by the synchronous machine.

30. The permanently excited synchronous machine of claim 12, wherein said coils of said winding are distributed on said stator so that the fifth and seventh harmonics have only a small amplitude.

31. The permanently excited synchronous machine of claim 12, further comprising phases in said winding, said coils being assigned to respective phases and coils assigned to a respective phase being connected in series.

32. The permanently excited synchronous machine of claim 14, further comprising two groups of coils within said coils assigned to a respective phase, said two groups of coils being connected in parallel. The permanently excited synchronous machine of claim 12, wherein said stator has two groups coils having n/2 coils each, the number of phases in said stator is φ, and n=φ2i+φ2i where I is an integer, and wherein said stator has 2ni slots and 2ni teeth, said two groups of coils being connected in parallel.

33. A permanently excited synchronous machine, comprising:
a stator; and
a rotor interacting with said stator, said rotor having permanent magnets providing a number of useful pole pairs, said number of useful pole pairs being a prime number, said stator having a three-phase winding and 36 slots and 36 teeth, every second tooth having a coil, each coil having either a first winding direction e or a second winding direction z, said first and second winding directions being opposite directions, coils of each phase U, V, and W being connected in series, said wound teeth being wound as follows:

| | Wound tooth | | | | | | | | | | | | | | | | | |
|---|---|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 | 17 | 18 |
| Phase U | e | z | | | | e | | | | z | e | | | | z | | | |
| Phase V | | | z | | | | e | Z | | | | e | | | | z | e | |
| Phase W | | | | z | e | | | | z | | | | e | z | | | | e |

34. The permanent-magnet synchronous machine of claim 33, wherein said rotor has 22 magnetic poles.

35. The permanent-magnet synchronous machine of claim 33, wherein
a) for the phase U coils on the first, second and sixth wound teeth are a first coil group for the phase U, and coils on the tenth, eleventh and fifteenth wound teeth are a second coil group for phase U, and
b) for the phase V coils on the third, sixteenth and seventeenth wound teeth are a first coil group for the phase V, and coils on the seventh, eighth and twelfth wound teeth are a second coil group for the phase V, and
c) for the phase W coils on the fourth, fifth and ninth wound teeth are a first coil group for the phase W, and coils on the thirteenth, fourteenth and eighteenth wound teeth are a second coil group for the phase W.

36. A permanently excited synchronous machine, comprising:
a stator having slots, teeth and a winding having coils wound on said teeth, wound teeth on said stator that are wound with one of said coils being separated by at least one unwound tooth that is not wound with one of said coils; and
a rotor interacting with said stator, said rotor having permanent magnets providing a number of useful magnetic pole pairs, said number of useful magnetic pole pairs being a prime number.

37. A torque motor, comprising:
a stator having slots, teeth and a winding having coils wound on said teeth, wound teeth on said stator that are wound with one of said coils being separated by at least one unwound tooth that is not wound with one of said coils; and
a rotor interacting with said stator, said rotor having permanent magnets providing a number of useful magnetic pole pairs, said number of useful magnetic pole pairs being a prime number.
